(19) United States
(12) Patent Application Publication
(10) Pub. No.: US 2022/0356307 A1
(43) Pub. Date: Nov. 10, 2022

(54) VULCANISABLE SILICONE COMPOSITIONS

(71) Applicants: DOW SILICONES CORPORATION, Midland, MI (US); ROHM AND HAAS COMPANY, Collegeville, PA (US)

(72) Inventors: Milton H. REPOLLET-PEDROSA, Midland, MI (US); Aaron SEITZ, Midland, MI (US); Glenn GORDON, Midland, MI (US); Michael BRASSEUR, Midland, MI (US); Justin GATHMAN, Midland, MI (US); Janah C. SZEWCZYK, Collegeville, PA (US)

(21) Appl. No.: 17/621,649

(22) PCT Filed: Jun. 23, 2020
(86) PCT No.: PCT/US2020/039034

§ 371 Date: Dec. 21, 2021

Related U.S. Application Data
(60) Provisional application No. 62/867,458, filed on Jun. 27, 2019.

(51) Int. Cl. C08G 77/16; C08K 5/5419; C08G 77/08; C08G 77/18

(52) U.S. Cl. CPC C08G 77/16; C08K 5/5419; C08G 77/08; C08G 77/18; C08G 2190/00; C08G 2150/00; C08G 2170/00

(57) ABSTRACT

A moisture curable composition capable of cure to an elastomeric body, the composition comprising: (i) an organopolysiloxane polymer having at least two silicon-bonded hydroxyl or hydrolysable groups per molecule and a viscosity of from 1,000 to 75,000 maPa·s at 25° C.; (ii) a siloxane and/or silane cross-linker; (iii) an organosilicate resin comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii); and (iv)_a condensation cure catalyst. The organosilicate resin (iii) is generally used to reinforce the composition.

This disclosure relates to elastomeric sealants, coating and adhesives comprising room temperature vulcanisable (RTV) silicone compositions which have a low viscosity (less than or equal to (≤) 30,000 mPa·s at 25° C.), while maintaining a high solids content (greater than or equal to (≥) 90%) which may improve tensile strength, modulus and tear strength properties and/or adhesiveness.

Organosiloxane compositions which cure to elastomeric solids are well known and such compositions can be produced to cure at room temperature in the presence of moisture and are obtained by mixing a polydiorganosiloxane based polymer having reactive terminal groups, with a suitable silane (or siloxane) based cross-linking agent in the presence of one or more fillers and a curing catalyst. These compositions are typically either prepared in the form of one-part compositions curable upon exposure to atmospheric moisture at room temperature or two-part compositions curable upon mixing at room temperature and pressure.

Dependent on the ingredients, such curable compositions may be used as sealants, coatings and/or adhesives. In the case of use as a sealant, it is important that the composition has a blend of properties which render it capable of being applied as a paste to a joint between substrate surfaces where it can be worked, prior to curing, to provide a smooth surfaced mass which will remain in its allotted position until it has cured into an elastomeric body adherent to the adjacent substrate surfaces. Typically, sealant compositions are designed to cure quickly enough to provide a sound seal within several hours but at a speed enabling the applied material to be tooled into a desired configuration shortly after application. The resulting cured sealant is generally formulated to have a strength and elasticity appropriate for the joint concerned.

Compositions as hereinbefore described having lower viscosities may be utilised as coatings and/or adhesives in a wide variety of applications e.g. in weatherproofing and/or construction applications.

For example, a wide variety of weatherproof coatings/adhesives may be used in both new building and remedial construction applications as barrier systems. These barrier systems may be designed to eliminate uncontrolled air and water leakage through e.g. exterior walls, roofing surfaces and/or facades thereby assisting in the control of temperature, humidity levels, moisture levels and air quality throughout a building by reducing and/or minimising, for example, the possibility of damp problems and/or the chance of mould growth and poor air quality from e.g. the ingress of airborne pollutants.

The application of such weatherproof coatings to constructions, e.g. cavity wall systems, results in energy cost savings and may significantly reduce the likelihood of mold growth and poor air quality and restricting the ingress of airborne pollutants by controlling or reducing the amount of air leakage through the exterior walls, roofing surfaces and/or facades of a building.

Elastomeric weatherproof coatings are usually designed to be either (water) vapour permeable or impermeable. Vapour Impermeable weatherproof coatings and/or adhesives effectively block the transfer of water vapour through the coating, whilst vapour permeable coatings control the amount of (water) vapour diffusing through a wall/roof due to variable vapour pressures. Unless prevented or controlled, water vapour will naturally move from a high concentration to a lower concentration until it is in balance. Hence, if the vapour pressure is high outside the wall/roof and low inside the wall/roof, vapour will be directed inward (and vice versa).

Many systems have been devised for providing roof coverings for buildings. One method uses pieces of water-impervious material, such as slate or wood, laid upon the roof in overlapping rows so that each joint is covered by the piece laid above it. Such roofing surfaces are satisfactory when the roof is pitched at a high angle so that there is no tendency for the water to flow back through the cracks between the pieces, however, where freezing occurs, ice occasionally forms on the lower edges of roofing surfaces to form a dam which forces water back through the cracks into the interior of the building. This may be avoided by application of a weather seal coating or the like.

Historically, silicone compositions comprised linear high molecular weight (MW) polysiloxanes coupled with inorganic reinforcing fillers (crystalline silica, calcium carbonates, etc.) to yield the solids, tensile strength, modulus and tear resistance required by ASTM D2370 and ASTM D-624 standards. One or more inorganic fillers is/are almost invariably added into an elastomeric composition containing an organopolysiloxane containing polymer to obtain useful tear, durometer, tensile and modulus at 100% elongation properties. However, the rheological properties of an uncured elastomer are heavily dependent on filler properties such as filler concentration and structure and the degree of polymer-filler interaction as well as the viscosity of the polymer. In general, the lower the viscosity of the uncured organopolysiloxane containing composition, the higher the extrusion rate of the uncured composition. As a result, coatings as well as sealants and/or adhesives requiring high extrusion rates need to typically be of relatively low viscosity (e.g. <100,000 mPa·s at 25° C.) to ensure suitable composition extrusion rates for manual end uses and as such can forfeit some of the properties gained by the addition of inorganic fillers to satisfy the extrudability requirements.

The present disclosure seeks to provide elastomeric sealants, coating and adhesives from room temperature vulcanisable (RTV) silicone compositions which have a low viscosity (less than or equal to (≤) 30,000 mPa·s at 25° C.), while maintaining a high solids content (greater than or equal to (≥) 90%), with a view to providing reinforcement whilst not significantly effecting the viscosity of the composition thereby enabling self-levelling.

There is provided a moisture curable composition capable of cure to an elastomeric body, the composition comprising

(i) an organopolysiloxane polymer having not less than two silicon-bonded hydroxyl or hydrolysable groups per molecule and a viscosity of from 1,000 to 75,000 mPa·s at 25° C., alternatively from 1000 to 60,000 mPa·s at 25° C.,
(ii) a siloxane and/or silane cross-linker having at least two groups per molecule which are reactable with the hydroxyl or hydrolysable groups in polymer (i);
(iii) an organosilicate resin comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) having weight average molecular weight of from 3000 to 30,000 g/mol, a molar ratio of M groups:Q groups of from 0.50:1 to 1.20:1; and
(iv) a condensation cure catalyst.

The moisture curable composition capable of cure to an elastomeric body as hereinbefore described is designed to provide improved tensile, modulus, tear resistance and or adhesion properties.

There is also provided a method for filling a space between two substrates, so as to create a seal therebetween, comprising:
a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and curing the silicone composition.

There is also provided a use of an organosilicate resin (iii) comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) having weight average molecular weight of from 3000 to 30,000 g/mol, a molar ratio of M groups:Q groups of from 0.50:1 to 1.20:1 to increase the tensile strength, modulus, tear resistance and/or adhesion properties of a cured elastomeric body resulting from curing a moisture curable composition capable of cure to an elastomeric body otherwise comprising

(i) an organopolysiloxane polymer having not less than two silicon-bonded hydroxyl or hydrolysable groups per molecule and a viscosity of from 1,000 to 75,000 mPa·s at 25° C., alternatively from 1000 to 60,000 mPa·s at 25° C.;
(ii) a siloxane and/or silane cross-linker having at least two groups per molecule which are reactable with the hydroxyl or hydrolysable groups in the polymer; and
(iv) a condensation cure catalyst.

There is also provided a method of improving tensile strength, modulus, tear resistance and/or adhesion of an elastomeric body obtained or obtainable by curing a moisture curable composition capable of cure to an elastomeric body comprising

(i) an organopolysiloxane polymer having not less than two silicon-bonded hydroxyl or hydrolysable groups per molecule and a viscosity of from 1,000 to 75,000 mPa·s at 25° C., alternatively from 1,000 to 60,000 mPa·s at 25° C.,
(ii) a siloxane and/or silane cross-linker having at least two groups per molecule which are reactable with the hydroxyl or hydrolysable groups in the polymer
(iv) a condensation cure catalyst,
by introducing an an organosilicate resin (iii) comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) having weight average molecular weight of from 3,000 to 30,000 g/mol, a molar ratio of M groups:Q groups of from 0.50:1 to 1.20:1 into the composition prior to cure, and subsequently curing the composition.

A silicone-based elastomer obtainable or obtained by curing a moisture curable composition as hereinbefore described which is capable of cure to an elastomeric body.

The moisture curable composition capable of cure to an elastomeric body as hereinbefore described may be a sealant composition, a coating composition or an adhesive composition.

The composition described above relies on the use of organosilicate resins (iii) comprising R²₃SiO_{1/2} (M) siloxane units and SiO_{4/2} (Q) siloxane units which M groups are reactive with components (i) and/or (ii), as reinforcing agents. Without being bound by current theories it is believed that using these organosilicate resins as reinforcing agents, provides an advantage in comparison to other reinforcing agents used in the art because of the miscibility of the resins (iii) with the organopolysiloxane polymer(s) (i) which causes a reduction in the entanglement molecular weight (Mₑ) of the organopolysiloxane polymer(s) (i) in the composition thereby avoiding increasing viscosity of the formulation. For the avoidance of doubt by entanglement molecular weight (Mₑ) it is meant the transition molecular weight of a polymer above which polymers are useful as e.g. plastics whilst polymers below the entanglement molecular weight (Mₑ) display features of low molecular weight materials. Hence, the above compositions provide the advantage of being low viscosity while maintaining high solids (≥90%) without the excessive use of solvent.

In accordance with the above composition, organopolysiloxane polymer (i) having at least two hydroxyl or hydrolysable groups per molecule has the formula

X₃₋ₙRₙSi—(Z)_{d}—(O)_{q}—(R¹_{y}SiO_{(4-y)/2)z}—(SiR¹₂—Z)_{d}—Si—RₙX₃₋ₙ (1)

in which each X is independently a hydroxyl group or a hydrolysable group, each
R is an alkyl, alkenyl or aryl group, each R¹ is an X group, alkyl group, alkenyl group or aryl group and Z is a divalent organic group;
d is 0 or 1, q is 0 or 1 and d+q=1; n is 0, 1, 2 or 3, y is 0, 1 or 2, and z is an integer such that said organopolysiloxane polymer (i) has a viscosity of from 1,000 to 75,000 mPa·s at 25° C., alternatively from 1,000 to 60,000 mPa·s at 25° C. measured in accordance with ASTM D1084 using a Brookfield rotational viscometer with spindle CP-52 at 1 rpm.

Each X group of organopolysiloxane polymer (i) may be the same or different and can be a hydroxyl group or a condensable or hydrolyzable group. The term “hydrolyzable group” means any group attached to the silicon which is hydrolysed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃.

The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy radicals, such as methoxymethoxy or ethoxymethoxy and alkoxyaryloxy, such as ethoxyphenoxy. The most preferred alkoxy groups are methoxy or ethoxy. When d=1, n is typically 0 or 1 and each X is an alkoxy group, alternatively an alkoxy group having from 1 to 3 carbons, alternatively a methoxy or ethoxy group. In such a case organopolysiloxane polymer (i) has the following structure:

X₃₋ₙRₙSi—(Z)—(R¹_{y}SiO_{(4-y)/2)z}—(SiR¹₂Z)Si RₙX₃₋ₙ

With R, R¹, y and z being as described above, n being 0 or 1 and each X being an alkoxy group.

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; and aromatic groups, alternatively aromatic groups having from 6 to 20 carbon atoms or substituted aliphatic organic groups such as 3,3,3-trifluoropropyl groups aminoalkyl groups, polyaminoalkyl groups, and/or epoxyalkyl groups.

Each R¹ is individually selected from the group consisting of X or R with the proviso that cumulatively at least 2 X groups and/or R¹ groups per molecule are hydroxyl or hydrolysable groups. It is possible that some R¹ groups may be siloxane branches off the polymer backbone which branches may have terminal groups as hereinbefore described. Most preferred R¹ is methyl.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene groups may for example be individually selected from an ethylene, propylene, butylene, pentylene and/or hexylene group.

Additionally n is 0, 1, 2 or 3, d is 0 or 1, q is 0 or 1 and d+q=1. In one alternatively when q is 1, n is 1 or 2 and each X is an OH group or an alkoxy group. In another alternative when d is 1 n is 0 or 1 and each X is an alkoxy group.

Organopolysiloxane polymer (i) has a viscosity of from 1,000 to 75,000 mPa·s at 25° C., alternatively from 1,000 to 60,000 mPa·s at 25° C. measured in accordance with ASTM D1084 using a Brookfield rotational viscometer with spindle CP-52 at 1 rpm, z therefore is an integer enabling such a viscosity, alternatively z is an integer from 300 to 5,000. Whilst y is 0, 1 or 2, substantially y=2, e.g. at least 90% alternatively 95% of R¹_{y}SiO_{(4-y)/2} groups are characterized with y=2.

Organopolysiloxane polymer (i) can be a single siloxane represented by Formula (1) or it can be mixtures of organopolysiloxane polymers represented by the aforesaid formula. Hence, the term “siloxane polymer mixture” in respect to component (i) is meant to include any individual organopolysiloxane polymer (i) or mixtures of organopolysiloxane polymer (i).

The Degree of Polymerization (DP), (i.e. in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by gel permeation chromatography (GPC) with precision of about 10-15%. This technique is standard and yields Mw, Mn and the polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity. Organopolysiloxane polymer (i) is going to be present in an amount of from 10 to 60% by weight, alternatively 10 to 55%, alternatively 20 to 55% by weight of the composition.

Cross-linker (ii) may be any suitable cross-linker. The cross-linker (ii) may be one or more silanes or siloxanes which contain silicon bonded hydrolysable groups such as acyloxy groups (for example, acetoxy, octanoyloxy, and benzoyloxy groups); ketoximino groups (for example dimethyl ketoximo, and isobutylketoximino); alkoxy groups (for example methoxy, ethoxy, iso-butoxy and propoxy) and alkenyloxy groups (for example isopropenyloxy and 1-ethyl-2-methylvinyloxy).

In the case of siloxane based cross-linkers the molecular structure can be straight chained, branched, or cyclic.

Cross-linker (ii) preferably has at least three or four hydroxyl and/or hydrolysable groups per molecule which are reactive with the hydroxyl and/or hydrolysable groups in organopolysiloxane polymer (i). When the cross-linker is a silane and when the silane has a total of three silicon-bonded hydroxyl and/or hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic groups are methyl.

Silanes and siloxanes which can be used as cross-linkers (ii) include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane. The cross-linker used may also comprise any combination of two or more of the above.

Alternatively, cross-linker (ii) may comprise a silyl functional molecule containing two or more silyl groups, each silyl group containing at least one —OH or hydrolysable group, the total of number of —OH groups and/or hydrolysable groups per cross-linker molecule being at least 3. Hence, a disilyl functional molecule comprises two silicon atoms each having at least one hydrolysable group, where the silicon atoms are separated by an organic or siloxane spacer. Typically, the silyl groups on the disilyl functional molecule may be terminal groups. The spacer may be a polymeric chain having a siloxane or organic polymeric backbone. In the case of such siloxane or organic based cross-linkers the molecular structure can be linear, branched, cyclic or macromolecular. In the case of siloxane based polymers the viscosity of the cross-linker will be within the range of from 0.5 mPa·s to 75,000 mPa·s at 25° C., alternatively from 0.5 mPa·s to 40,000 mPa·s at 25° C. measured in accordance with ASTM D1084 using a Brookfield rotational viscometer with spindle CP-52 at 1 rpm.

For example, cross-linker (ii) may be a disilyl functional polymer, that is, a polymer containing two silyl groups, each having at least one hydrolysable group such as described by the formula

RₙSi(X)₃₋ₙ—R³—Si(X)₃₋ₙRn

where each R, X and n may be individually selected as hereinbefore described above. R³ is an alkylene (divalent hydrocarbon radical), alternatively an alkylene group having from 1 to 10 carbon atoms, or further alternatively 1 to 6 carbon atoms or a combination of said divalent hydrocarbon radicals and divalent siloxane radicals. Preferred di-silyl functional polymer cross-linkers have n=0 or 1, X═OMe and R³ being an alkylene group with 4 to 6 carbons.

Examples of disilyl polymeric cross-linkers with a silicone or organic polymer chain bearing alkoxy functional end groups include polydimethylsiloxanes having at least one trialkoxy terminal where the alkoxy group may be a methoxy or ethoxy group. Examples might include or 1, 6-bis(trimethoxy silyl)hexane, hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxy tetrasiloxane.

The amount of cross-linker (ii) present in the composition will depend upon the nature of the cross-linker and in particular, the molecular weight of the molecule selected. The compositions suitably contain cross-linker in at least a stoichiometric amount as compared to organopolysiloxane polymer (i) described above.

Component (iii) is an organosilicate resin comprising an comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) having weight average molecular weight of from 3,000 to 30,000 g/mol, measured by GPC, a molar ratio of M groups:Q groups of from 0.50:1 to 1.20:1.

The organosilicate resins (iii) are reactive with components (i) and (ii). For the sake of the disclosure herein the term reactive with respect to component (iii) shall be understood to mean organosilicate resins containing >1% by weight of —OH and/or hydrolysable groups, especially >2% by weight of —OH and/or hydrolysable groups, alternatively —OH groups is considered reactive as they should contain —OH and/or hydrolysable groups, attached to terminal groups which are chemically available (i.e. sterically unhindered) to react with groups from components (i) and (ii).

Siloxy units may be described by a shorthand (abbreviated) nomenclature, namely—“M,” “D,” “T,” and “Q”, when R′ is e.g. a methyl group (further teaching on silicone nomenclature may be found in Walter Noll, Chemistry and Technology of Silicones, dated 1962, Chapter I, pages 1-9). The M unit corresponds to a siloxy unit where a=3, that is R′3SiO_{1/2}; the D unit corresponds to a siloxy unit where a=2, namely R′₂SiO_{2/2}; the T unit corresponds to a siloxy unit where a=1, namely R′₁SiO_{3/2}; the Q unit corresponds to a siloxy unit where a=0, namely SiO_{4/2}. Hence, organosilicate resin (iii) may be referred to as an MQ resin, when only M and Q groups are present.

In the formula for organosilicate resin (iii), R² denotes a monovalent group selected from hydrocarbon groups, —OH and/or hydrolysable groups, which hydrolysable groups are preferably alkoxy groups with the proviso that >1% by weight of resin (iii) are R² groups which are reactive with components (i) and (ii), typically —OH or hydrolysable groups, which hydrolysable groups are particularly alkoxy groups. Alternatively, organosilicate resin (iii), shall contain from >0.7% up to 5% by weight R² groups, alternatively from >0.8% up to 2.5% by weight R² groups which are reactive with components (i) and (ii), typically —OH or hydrolysable groups, particularly alkoxy groups. In one embodiment the R² hydrocarbon groups may have from 1 to 20 carbon atoms, alternatively from 1 to 10 carbon atoms. Examples of suitable hydrocarbon groups include alkyl radicals, such as methyl, ethyl, propyl, pentyl, octyl, undecyl and octadecyl; cycloaliphatic radicals, such as cyclohexyl; aryl radicals such as phenyl, tolyl, xylyl, benzyl, alpha-methyl styryl and 2-phenylethyl; alkenyl radicals such as vinyl; and alkoxy containing groups may include alkoxy groups having from 1 to 10 carbons e.g., methoxy, ethoxy, propoxy and/or butoxy groups, alternatively methoxy groups or groups of the formula

—R₂Si—Z—SiRₚ(OR⁶)₃₋ₚ

wherein R and Z are as defined above, R⁶ is an alkyl group having from 1 to 10 carbons and p is 0, 1 or 2, alternatively 0 or 1, alternatively 0. Resins (iii) containing the —R₂Si—Z— SiRₚ(OR⁶)₃₋ₚ groups may be prepared by having MQ resins with vinylated M groups such as (CH₃)₂ViSi—O_{1/2} undergo a hydrosilylation reaction with an Si—H containing compound such as trimethoxysilylethyl-1,1,3,3-tetramethyldisiloxane

H(CH₃)₂Si—O—(CH₃)₂Si—(CH₂)₂—Si—(OMe)₃.

Preferably, at least two-thirds and, more preferably, substantially more than 95% by weight of R² non-reactive groups in component (iii), are alkyl groups containing between 1 and 6 carbons, alternatively methyl or ethyl groups, alternatively methyl groups and/or aryl groups.

Organosilicate resin (iii) includes a resinous portion wherein the R²₃SiO_{1/2} siloxane units (i.e., M units) are bonded to the SiO_{4/2} siloxane units (i.e., Q units), each of which Q group is bonded to at least one other SiO_{4/2} siloxane unit. Some SiO_{4/2} siloxane units are bonded to hydroxyl radicals resulting in HOSiO_{3/2} units (which may be referred to as TOH units), however, substantially all (i.e. >95%) of such groups are situated within the resinous structure and thereby are non-reactive with other components within the composition, i.e. components (i) and (ii) as discussed above, In addition to the resinous portion, component (iii) can contain a small amount of a low molecular weight material comprised substantially of a neopentamer organopolysiloxane having the formula (R²₃SiO)₄Si, the latter material being a byproduct in the preparation of the organosilicate resin.

The molar ratio of R²₃SiO_{1/2} (M) siloxane units to SiO_{4/2} (Q) siloxane units in resin (iii) is from 0.5 to 1.2, alternatively 0.6 to 1.2, alternatively between 0.6 and 0.8. The above M/Q molar ratios can be easily obtained by ²⁹Si nuclear magnetic resonance (NMR), this technique being capable of a quantitative determination of the molar contents of: M (resin), M(neopentamer), Q (resin), Q(neopentamer) and TOH. For the purposes of the present invention, as implicitly stated supra, the M/Q ratio {M(resin)+M(neopentamer)}/{Q(resin)+Q(neopentamer)} represents the ratio of the total number of triorganosiloxy groups of the resinous and neopentamer portions of (iii) to the total number of silicate groups of the resinous and neopentamer portions of (iii). It will, of course, be understood that the above definition of the M/Q molar ratio accounts for the neopentomer resulting from the preparation of organosilicate resin (iii) and not for any intentional addition of neopentomer.

Organosilicate resin (iii) may be a solid at room temperature, alternatively organosilicate resin (iii) is a solid at room temperature. That is, when a solid at room temperature, organosilicate resin (iii) has a softening point above room temperature (RT) i.e. >25° C., preferably above 40° C.

The resinous portion of component (iii) has a weight average molecular weight (Mw) of 3,000 to 30,000 g/mol when measured by gel permeation chromatography (GPC), the neopentamer peak being excluded from the measurement. In this molecular weight determination, narrow fractions of MQ resins are used to calibrate the GPC equipment, the absolute molecular weights of the fractions being first ascertained by a technique such as vapor phase osmometry. Typically, as previously indicated organosilicate resin (iii) is deemed reactive because it contains >1% by weight of —OH groups and/or hydrolysable groups e.g., alkoxy containing groups. The hydrolysable groups may include e.g. groups of the formula

—R₂Si—Z—SiRₚ(OR⁶)₃₋ₚ

wherein R and Z are as defined above, R⁶ is an alkyl group having from 1 to 10 carbons and p is 0, 1 or 2, alternatively 0 or 1, alternatively 0.

Organosilicate resin (iii) can be prepared by any suitable well-known method. It is preferably prepared by the silica hydrosol capping process of U.S. Pat. No. 2,676,182; as modified by U.S. Pat. Nos. 3,627,851 and 3,772,247. These methods employ an organic solvent, such as toluene or xylene and provide a solution wherein the resin typically has a hydroxyl and/or hydrolysable groups, alternatively —OH group content greater than one percent (based on the weight of resin solids) up to 10% by weight i.e. reactive resins (iii) are prepared with a value of between 2 to 4 percent by weight of —OH and/or hydrolysable groups, alternatively —OH groups. If required, the resulting resin may be capped with alkenyl, alternatively vinyl groups to enable —R₂Si—Z—SiRₚ(OR⁶)₃₋ₚ groups to be terminally attached vis a hydrosilylation reaction.

By using reactive resins (iii) to reinforce the compositions the present disclosure demonstrates improved mechanical properties without substantially affecting the overall viscosity of the formulation. The ability of the MQ resin to form a continuous network enables high tensile strength and modulus, while the strong network aids the dissipation the tear energy among the film is the mechanism by which the enhanced performance is observed. The mechanism described above occurs for reactive and non-reactive resins. However, the reactive resins participate of the crosslinking network formation, therefore we observe higher tensile and modulus properties than non-reactive resins. In one embodiment the molar ratio of organopolysiloxane polymer (i) to organosilicate resin (iii) is a minimum of 1:1, i.e. typically there is more of organopolysiloxane polymer (i) present than there is of organosilicate resin (iii) It was found that if the cumulative molar amount of organopolysiloxane polymer (i) and organosilicate resin (iii) contains >50% of organosilicate resin (iii) the composition tended to become too thick for the applications concerned. Typically, there is from 10 to 25% by weight of organosilicate resin (iii) in the composition.

Some of the compositions disclosed herein do not require a catalyst to aid in curing the composition although suitable catalysts may be used if appropriate. Hence, the composition may comprise a condensation catalyst (iv). This increases the speed at which the composition cures. The catalyst (iv) chosen for inclusion in a particular silicone sealant composition depends upon the speed of cure required.

Catalyst (iv) may be a tin based catalyst. Tin based catalysts are typically used in compositions which are stored in two parts and mixed together immediately prior to use as discussed further below. Suitable tin based condensation catalysts (iv) include tin triflates, organic tin metal catalysts such as triethyltin tartrate, tin octoate, tin oleate, tin naphthenate, butyltintri-2-ethylhexoate, tin butyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate, dibutyltin dibenzoate, stannous octoate, dimethyltin dineodecanoate (DMTDN) and dibutyltin dioctoate. The tin catalyst may be present in an amount of from 0.01 to 3 weight % by weight of the composition; alternatively, 0.1 to 0.75 weight % of the composition.

Titanate and/or zirconate based catalysts (iv) are more often utilised in one-part sealant compositions, i.e. compositions not requiring mixing prior to use. Suitable titanate and/or zirconate based catalysts (iv) may comprise a compound according to the general formula M[OR²²]₄ where M is titanium or zirconium and each R²² may be the same or different and represents a monovalent, primary, secondary or tertiary aliphatic hydrocarbon group which may be linear or branched containing from 1 to 10 carbon atoms. Optionally the titanate or zirconate may contain partially unsaturated groups. However, preferred examples of R²² include but are not restricted to methyl, ethyl, propyl, isopropyl, butyl, tertiary butyl and a branched secondary alkyl group such as 2, 4-dimethyl-3-pentyl. Preferably, when each R²² is the same, R²² is an isopropyl, branched secondary alkyl group or a tertiary alkyl group, in particular, tertiary butyl. Suitable examples include for the sake of example, tetra n-butyl titanate, tetra t-butyl titanate, tetra t-butoxy titanate, tetraisopropoxy titanate and diisopropoxydiethylacetoacetate titanate. Alternatively, the titanate or zirconate may be chelated. The chelation may be with any suitable chelating agent such as an alkyl acetylacetonate such as methyl or ethylacetylacetonate. Alternatively, the titanate may be monoalkoxy titanates bearing three chelating agents such as for example 2-propanolato, tris isooctadecanoato titanate. The titanium or zirconium catalyst may be present in an amount of from 0.01 to 3 weight % by weight of the composition; alternatively, 0.1 to 0.75 weight % of the composition.

### Optional Additives

Compositions as hereinbefore described may contain one or more inorganic fillers. The inorganic fillers may be reinforcing or non-reinforcing. Reinforcing inorganic fillers may contain one or more finely divided, inorganic reinforcing fillers such as precipitated calcium carbonate, fumed silica and/or precipitated silica including, for example, rice hull ash. Typically, the surface area of the inorganic reinforcing filler is at least 15 m²/g in the case of precipitated calcium carbonate measured in accordance with the BET method in accordance with ISO 9277: 2010, alternatively 15 to 50 m²/g, alternatively 15 to 25 m²/g in the case of precipitated calcium carbonate. Silica reinforcing fillers have a typical surface area of at least 50 m²/g. In one embodiment, when present, the inorganic reinforcing filler is a precipitated calcium carbonate, precipitated silica and/or fumed silica; alternatively, precipitated calcium carbonate. In the case of high surface area fumed silica and/or high surface area precipitated silica, these may have surface areas of from 100 to 400 m²/g measured in accordance with the BET method in accordance with ISO 9277: 2010, alternatively of from 100 to 300 m²/g in accordance with the BET method in accordance with ISO 9277: 2010, may be chosen for use. Typically, when present, inorganic reinforcing fillers are present in the composition in an amount of from 20 to 500% by weight of the composition, alternatively from 25 to 50% by weight of the composition, alternatively from 30 to 50% by weight of the composition.

When present inorganic reinforcing filler may be hydrophobically treated for example with a fatty acid e.g. stearic acid or a fatty acid ester such as a stearate, or with organosilanes, organosiloxanes, or organosilazanes hexaalkyl disilazane or short chain siloxane diols e.g. methylvinylsiloxanes diols, to render the inorganic filler(s) hydrophobic and therefore easier to handle and obtain a homogeneous mixture with the other components of the composition. The surface treatment of the fillers makes them easily wetted by polymer (i). When present, these surface modified inorganic fillers do not clump and can be homogeneously incorporated into the silicone polymer (i). This results in improved room temperature mechanical properties of the uncured compositions. The fillers may be pre-treated or may be treated in situ when being mixed with polymer (i).

Non-reinforcing inorganic fillers, which might be used alone or in addition to the above include aluminite, calcium sulphate (anhydrite), gypsum, nepheline, svenite, quartz, calcium sulphate, magnesium carbonate, clays such as kaolin, aluminium trihydroxide, magnesium hydroxide (brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅.

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO_{3].}

The sheet silicates group comprises silicate minerals, such as but not limited to, mica; K₂AI₁₄[Si₆Al₂O₂₀](OH)₄; pyrophyllite; AI₄[Si₈O₂₀](OH)₄; talc; Mg₆[Si₈O₂₀](OH)₄; serpentine for example, asbestos; Kaolinite; AI₄[Si₄O₁₀](OH)₈; and vermiculite.

The inorganic non-reinforcing fillers may also be hydrophobically treated as described above.

The composition as hereinbefore described may be utilised for e.g. sealants, coatings and/or adhesives and the different uses may necessitate the inclusion of one or more other optional additives for optimum utility. These may include one or more of the following, dependent on end use:

### Plasticisers and Extenders

The composition as hereinbefore described may comprise a plasticizer or extender (sometimes referred to as a processing aid) in the form of a silicone or organic fluid which is unreactive with organopolysiloxane polymer(s) (i) crosslinker(s) (ii) and organosilicate resin (iii), whether reactive or unreactive. If present the plasticizer or extender content will be present in an amount of from 5 to 20% weight, alternatively from 5 to 10% by weight.

Examples of non-reactive silicone fluids useful as plasticizers and which may be included in the two part composition, include polydiorganosiloxanes such as polydimethylsiloxane having terminal triorganosiloxy groups wherein the organic substituents are, for example, methyl, vinyl or phenyl or combinations of these groups. Such polydimethylsiloxanes can for example have a viscosity of from about 5 to about 100,000 mPa·s at 25° C. When present, these can be in part A or in part B of the two-part composition with a cross-linker and catalyst.

Alternatively compatible organic plasticisers may be utilised additionally to or instead of the silicone fluid plasticiser include dialkyl phthalates wherein the alkyl group may be linear and/or branched and contains from six to 20 carbon atoms such as dioctyl, dihexyl, dinonyl, didecyl, diallanyl and other phthalates, and analogous adipate, azelate, oleate and sebacate esters; polyols such as ethylene glycol and its derivatives; and organic phosphates such as tricresyl phosphate and/or triphenyl phosphates.

Examples of extenders for use in compositions herein include mineral oil based (typically petroleum based) paraffinic hydrocarbons, mixtures of paraffinic and naphthenic hydrocarbons, paraffin oils comprising cyclic paraffins and non-cyclic paraffins and hydrocarbon fluids containing naphthenics, polycyclic naphthenics and paraffins, or polyalkylbenzenes such as heavy alkylates (alkylated aromatic materials remaining after distillation of oil in a refinery). Examples of such extenders are discussed in GB2424898 the content of which is hereby enclosed by reference.

Other ingredients which may be included in the two part composition include but are not restricted to rheology modifiers; adhesion promoters, pigments, heat stabilizers, flame retardants, UV stabilizers, chain extenders, cure modifiers, electrically and/or heat conductive fillers, and fungicides and/or biocides and the like.

### Rheology Modifiers

Rheology modifiers which may be incorporated in moisture curable compositions according to the invention include silicone organic co-polymers such as those described in EP 0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion of the sealant to substrates, particularly plastic substrates.

### Adhesion Promoters

Examples of adhesion promoters which may be incorporated in moisture curable compositions according to the invention include alkoxysilanes such as aminoalkylalkoxysilanes, for example 3-aminopropyltriethoxysilane, epoxyalkylalkoxysilanes, for example, 3-glycidoxypropyltrimethoxysilane and, mercapto-alkylalkoxysilanes, and reaction products of ethylenediamine with silylacrylates. Isocyanurates containing silicon groups such as 1, 3, 5-tris(trialkoxysilylalkyl) isocyanurates may additionally be used. Further suitable adhesion promoters are reaction products of epoxyalkylalkoxysilanes such as 3-glycidoxypropyltrimethoxysilane with amino-substituted alkoxysilanes such as 3-aminopropyltrimethoxysilane and optionally with alkylalkoxysilanes such as methyltrimethoxysilane.

### Chain Extenders

Chain extenders may include difunctional silanes which extend the length of the polysiloxane polymer chains before cross linking occurs and, thereby, reduce the modulus of elongation of the cured elastomer. Chain extenders and crosslinkers compete in their reactions with the functional polymer ends; in order to achieve noticeable chain extension, the difunctional silane must have substantially higher reactivity than the trifunctional crosslinker with which it is used. Suitable chain extenders include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethoxydimethylsilane, diethoxydimethylsilane and α-aminoalkyldialkoxyalkylsilanes, polydialkylsiloxanes having a degree of polymerization of from 2 to 25 and having at least two acetamido or acetoxy or amino or alkoxy or amido or ketoximo substituents per molecule, and diketoximinosilanes such as dialkylkdiketoximinosilanes and alkylalkenyldiketoximinosilanes.

### Pigments

Pigments are utilised to colour the composition as required. Any suitable pigment may be utilised providing it is compatible with the composition. In two-part compositions pigments and/or coloured (non-white) fillers e.g. carbon black may be utilised typically in one part of the composition and may be relied upon to show good mixing of the different parts prior to application.

### Solvents

These may be similar to extenders and or plasticisers but are typically low viscosity fluids (<100 mPa·s at 25° C.) including but not limited to trimethyl terminated polydimethylsiloxanes, xylene, toluene, tertiary butyl acetate naphtha, mineral spirits and ethyl acetate.

### Biocides

Biocides may additionally be utilized in the composition if required. It is intended that the term “biocides” includes bactericides, fungicides and algicides, and the like. Suitable examples of useful biocides which may be utilised in compositions as described herein include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds andisothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl]methyl]-1H-1,2,4-triazole.

The fungicide and/or biocide may suitably be present in an amount of from 0 to 0.3% by weight of the composition and may be present in an encapsulated form where required such as described in EP2106418.

As discussed briefly above, the silicone elastomeric body as hereinbefore described is typically made from a condensation curable composition which may be stored in a single component, if uncatalyzed or catalysed with a titanium and/or zirconium based catalyst or may be stored in a 2 part manner, particularly if cured in the presence of a tin based catalyst. Two-part compositions may be mixed using any appropriate standard two-part mixing equipment with a dynamic or static mixer and is optionally dispensed therefrom for use in the application for which it is intended. Because resin (iii) is reactive, when the condensation curable composition is stored in two parts, the composition may be stored as follows, having polymer (i) and/or resin (iii) together with cross-linker (ii) in one part and polymer (i) and/or resin (iii) together with catalyst (iv) in the other part. In an alternative embodiment the condensation curable composition is stored in two parts having cross-linker (ii) in one part and polymer (i), resin (iii) and catalyst (iv) in the other part. In a still further embodiment the condensation curable composition is stored in two parts having a polymer (i), resin (iii) and optionally cross-linker (ii) in one part and a cross-linker (ii) and catalyst (iv) in the other part.

As previously indicated a composition as described above may be utilised for a variety of end applications, particularly as sealants, coatings and adhesives and the compositions will be designed to have appropriate viscosities for the end purpose concerned, i.e. coatings for roofing surfaces and or other construction substrates may be of a very low viscosity in order for the composition to be applied by brush or spray whereas adhesives and/or sealants may have higher viscosities. That said of course one of the advantages is that the viscosities are achieved with a 90%+solids content, i.e. avoiding the introduction of significant amounts of solvents, due to the reliance on the resins as the reinforcing means.

In the case when the end-product is used as a sealant, the composition herein may be provided in either a non-sag formulation or in a self-levelling formulation. A self levelling formulation means it is “self-levelling” when extruded from the storage container into a horizontal joint; that is, the sealant will flow under the force of gravity sufficiently to provide intimate contact between the sealant and the sides of the joint space. This allows maximum adhesion of the sealant to the joint surface to take place. The self-levelling also does away with the necessity of tooling the sealant after it is placed into the joint, such as is required with a sealant which is designed for use in both horizontal and vertical joints. A non-sag composition unlike the latter typically will not visibly flow under the force of gravity and typically needs tooling into the position/joint which it is intended to seal. There is provided herein a sealant composition as described above capable of being applied as a paste to a joint between two adjacent substrate surfaces where it can be worked, prior to curing, to provide a smooth surfaced mass which will remain in its allotted position until it has cured into an elastomeric body adherent to the adjacent substrate surfaces.

The use of a relatively low viscosity composition at least partially reliant on resin (iii) for reinforcement is particularly beneficial for self-levelling sealant compositions because reinforcement is provided without a significant increase in composition viscosity. Such self-levelling sealants may be used as highway sealants in the sealing of asphalt pavement. Asphalt paving material is used to form asphalt highways by building up an appreciable thickness of material (e.g. a thickness of about 20.32 cm), and for rehabilitating deteriorating concrete highways by overlaying with a layer which might as thick as 10.16 cm or even greater if deemed necessary. In both instances the asphalt overlays may undergo a phenomenon known as reflection cracking in which cracks form in the asphalt overlay due to the movement of the underlying concrete at the joints present in the concrete. These reflection cracks need to be sealed to prevent the intrusion of water into the crack, which will cause further destruction of the asphalt pavement when the water freezes and expands and self-levelling silicone sealants are excellent for this purpose. Hence, this provides a composition in which reinforcement is provided whilst viscosity of the composition is not significantly increased thereby enabling self-levelling of the composition to occur upon application onto a substrate.

The ability of a sealant as hereinbefore described to flow out upon application into a crack because reinforcement does not significantly increase the composition viscosity prior to curing enables the sealant to self-level, i.e. to have sufficient flow, under the force of gravity, to form an intimate contact with the sides of irregularly cracked walls and form a good bond and avoids the necessity of tooling the sealant after it has been introduced into the crack.

Alternatively, when the composition provided herein is being utilised as an elastomeric coating formulation, e.g. as a barrier coating for construction materials or as a weatherproof coating for a roof, the composition may have a viscosity not dissimilar to a paint thereby enabling application by e.g. brush, roller or spray gun or the like. A coating composition as described herein, when applied onto a substrate, may be designed to provide the substrate with e.g. long-term protection from air and water infiltration, under normal movement situations caused by e.g. seasonal thermal expansion and/or contraction, ultra-violet light and the weather. Such a coating composition can maintain water protection properties even when exposed to sunlight, rain snow or temperature extremes.

Hence, there is also provided herein a wall and/or roof assembly comprising an elastomeric coating resulting from curing a liquid applied, composition as hereinbefore described. The composition may be applied on to a substrate at any suitable wet thickness, such as for example from 0.50 mm to 1.75, alternatively 0.50 mm to 1.5 mm and may dry subsequent to application to a dry thickness of from 0.25 mm to 0.80 mm. It may applied onto any suitable construction substrate, such as a roofing substrate, a construction sheathing substrate, a metal substrate such as a painted or unpainted aluminium substrate, a galvanized metal substrate, a wood framing substrate, concrete masonry, foam plastic insulated sheeting, exterior insulation, pre-formed concrete, cast in place concrete wood framing, oriented strand board (OSB), exterior sheathing, a preformed panel, plywood and wood, a steel stud wall, roofing felting for roofing membranes, and/or anon-permeable wall assembly.

In the case of a roofing surface, The roofing surface may be of any suitable construction material for example, slates and tiles and/or reinforced concrete; nailable, lightweight concrete; poured gypsum; formed metal; and wood, (e.g. in the form of planks or plywood sheets) as well as single ply roofing membranes such as ethylene propylene diene monomer rubber (EPDM), thermoplastic olefins (TPO) and modified bitumen (mod-bit) base sheets, cap sheets or flashings.

Given silicone materials are significantly more resistant to temperature change than many alternatives used to form elastomeric roofing membranes, or to repair waterproof membranes an elastomeric coating made from the composition as hereinbefore described will remain elastomeric at high and low temperatures and as such is far less likely to split or crack due to building movements and/or temperature variation not least because of the reinforcement by resin (iii). Furthermore, even if moisture penetration does occur e.g. due to a faulty moisture barrier layer in the roofing construction (e.g. under a layer of roof insulation), the moisture can escape through the silicone elastomeric coating on the membrane, even though it is impervious to liquid water. Indeed, one added advantage is that a composition as provided herein may also be utilised as the aforementioned moisture barrier, which will of course be an added advantage from a compatibility perspective.

As previously indicated compositions as hereinbefore described may also be utilised as vapor barriers in a roofing system in combination with e.g. insulation materials. They may be placed in any suitable order to form the roof. Typical insulation materials may include, for the sake of example mineral or vegetable fiber boards, rigid glass fiber insulation, glass-bead board, rigid urethane board or sprayed coating, foamed polystyrene board, and composite board. The insulation may be attached to the roof deck with adhesives such as an adhesive composition as hereinbefore described other adhesives and/or mechanical fasteners if preferred.

In one embodiment there is provided a method of weatherproofing a roofing surface by applying an elastomeric coating composition as hereinbefore described over a roofing surface or substrate using the following sequential steps:—(A) laying a piece or pieces of roofing fabric over a roofing construction substrate surface; (B) if required bonding pieces of roofing fabric together at any seams; (C) adhering the roofing fabric to the roofing construction substrate surface at least at all edges and projections; (D) coating the roofing fabric with an elastomeric coating composition as hereinbefore described; and (E) Curing the elastomeric coating composition to form a water impermeable membrane.

Typically, the elastomeric coating composition will at least partially penetrate the roofing fabric prior to cure and as such the resulting elastomeric coating will be in and/or on the roofing fabric once cured.

The roofing construction substrate may be of any suitable material. For example, it may consist of a structured deck of wood, concrete and or metal on which are one or more layers of vapour barrier(s) and/or insulation. Indeed, the vapour barrier provided may be a layer of the composition as hereinbefore described.

In a still further embodiment there is provided a method of coating a pre-prepared weatherproof roofing membrane by coating said membrane with at least one coat of an elastomeric coating composition as hereinbefore described and allowing said coating to cure. In such a process the coating may be a top-coat for a new roof to enhance weatherproofing or may be used as a remedial renovating process in situ as a means of weatherproofing a leaking roof and or roofing membrane.

In the case of the remedial renovating process, this may be carried out e.g. by applying a layer of the coating composition as hereinbefore described directly onto a roofing membrane surface. In such a situation the roofing surface will typically be a waterproof roofing membrane (e.g. as described above) on top of any appropriate roofing construction. For example, it may consist of a structured deck of wood, concrete and or metal on which are one or more layers of vapour barrier(s) and/or insulation on top of which is the waterproof roofing membrane and the composition herein is applied on top of the waterproof roofing membrane as a remedial measure.

In a still further embodiment of the present disclosure an elastomeric coating composition as hereinbefore described may be utilised in the preparation of a waterproof roofing membrane by treating a roofing fabric with an elastomeric coating composition as hereinbefore described such that the roofing fabric onto which the composition is applied, effectively acts as a reinforcement for the silicone elastomeric coating resulting from application and curing the composition. Any suitable roofing fabric can be used, but roofing fabric constructed of fibers which do not absorb excessive amounts of water and which have some degree of elasticity are preferred, e.g. felt and nonwoven roofing fabrics are preferable. These may include but are not restricted to polypropylene and polyester fibers made into nonwoven roofing fabric and spun-bonded roofing fabric. Typically, the roofing fabric may be up to about 3 mm thick, alternatively from about 0.1 mm to 2 mm.

The roofing fabric can be adhered to the roofing construction surface as it is being laid, although there is no necessity, usually to adhere all the roofing fabric to the surface under it. For example, a composition as hereinbefore described may be applied to the roofing frame or support surface in a random pattern of spots or lines and then the roofing fabric can be placed over the adhesive and be pressed down into the adhesive. If it is desired to adhere the complete roofing fabric on to the roofing surface the silicone adhesive might be applied by brush or spray or rolling on to the roofing surface before application of the roofing fabric with the roofing fabric being subsequently placed onto the adhesive coating.

A composition as hereinbefore described may be utilised as an adhesive. In one example the adhesive might be used for adhering two suitable substrates together, e.g. for bonding in a roofing application adhering roofing fabric seams together and/or for adhering a roofing fabric to a roofing substrate. The adhesive may be extruded from a storage tube or the like around the edge of the roofing surface, then the roofing fabric may be placed on top of the adhesive and then pressed down over the bead of adhesive. When the adhesive cures, it bonds the roofing fabric to the roofing surface. In some cases, depending upon the nature of the roofing surface and the type of adhesive being used, it may be necessary to first prime the roofing surface before applying the adhesive. Other applications where the composition as hereinbefore described is used as an adhesive includes but ae not limited use a flashing adhesive.

A liquid elastomeric composition as hereinbefore described may be utilised, providing the uncured composition has a sufficiently low viscosity, may be applied onto suitable substrates by spraying, brushing, or rolling or flooding and squeegeeing. When used as a remedial topcoat or as a means of forming a waterproof membrane on a new roofing construction, the composition herein may be designed to cure at a speed such that the skin over time (SOT) is from about 20 minutes to 3 hours, alternatively 30 minutes to 2 hours, alternatively from 30 minutes to one hour. The skin over time is the time taken for a cured skin to occur at the air/coating interface. An SOT time of this duration is advantageous because the user needs a sufficient application and working time period to apply and if necessary work the composition and as such a fast curing composition, e.g. curing in 15 minutes or less after application is not generally desired for these types of applications. If required two or more coats of the coating composition as hereinbefore described may be applied onto a substrate, typically drying the first coat before applying the second.

The following examples are included for illustrative purposes only and should not be construed as limiting the disclosure herein which is properly set forth in the appended claims. All viscosities were measured at 25° C. using a Brookfield rotational viscometer in accordance with ASTM D 6694, using spindle 4 at 6 RPM unless otherwise indicated. The amount of each component of a composition present is provided in weight % (% wt.). All wet peel adhesion tests were undertaken in accordance ASTM C794 with one modification, Tietex® Roofing Fabric from Tietex International Limited of Spartanburg, S.C., USA was used as the substrate instead of the usual metal wire mesh.

### Coating Compositions

Table 1a provides the formulations used in a series of coating examples. It will be seen that the Ref. example contains no resin and Ex. 1 to 3 all comprise an amount of a non-reactive resin 1. In the Table:

Polymer 1 is a polydimethylsiloxane terminated with (CH₃O)₃—Si—(CH₂)₂—Si—
(i.e. structure 1

X₃₋ₙRₙSi—(Z)_{d}—(O)_{q}—(R¹_{y}SiO_{(4-y)/2)z}—(SiR¹₂—Z)_{d}—Si—RₙX₃₋ₙ (1)

where each X is a methoxy group, Z is a diethylene group, n is zero and d is 1, having a viscosity of 2000 mPa·s at 25° C.;
Resin 1 is a reactive resin as hereinbefore described having terminal groups of the type —Si(CH₃)₂— (CH₂)₂—Si— (OMe)₃ as discussed above prepared by capping approximately one third of the vinyl groups in a dimethylvinyl terminated MQ resin having a vinyl content of 2.2 weight %, a molar ratio of M groups to Q groups of 43:57 and M_{w} of 21,000, with trimethoxysilylethyl-1,1,3,3-tetramethyldisiloxane via a hydrosilylation reaction.
Treated ground CaCO₃ is a ground calcium carbonate treated with ammonium stearate having an average particle size of 3 μm.

TABLE 1a

| | Ref. A | Ex. 1 E | Ex. 2D |
|---|---|---|---|
| | (% wt.) | (% wt.) | (% wt.) |
| Polymer 1 | 50.0 | 30.0 | 34 |
| Resin 1 | | 20.0 | 16.0 |
| Methyltrimethoxysilane | 3.0 | 3.0 | 3.0 |
| Titanium diisopropyldiethylacetoacetate | 0.75 | 0.75 | 0.75 |
| Aminoethylaminopropyltrimethoxysilane | 0.04 | 0.04 | 0.04 |
| Titanium dioxide: pigment | 5.00 | 5.00 | 5.00 |
| Treated ground CaCO₃ (non-reinforcing) | 41.21 | 41.21 | 41.21 |

Table 1b provides details of the physical properties of the resin reinforced compositions depicted in Table 1a. APP is atactic polypropylene.

TABLE 1b

| | Ref. 1 | Ex. 1 | Ex. 2D |
|---|---|---|---|
| Viscosity (mPa · s at 25° C.) | 14000 | 24,000 | 25,000 |
| (ASTM D6694—15) | | | |
| 7 day Tensile strength (MPa) | 1.19 | 305 | 275 |
| (ASTM D2370) | | | |
| 7 day Elongation, % (ASTM D2370) | 142.2 | 244 | 196 |
| 7 day Tear Resistance (N/mm) | 4.41 | 37 | 31 |
| (ASTM D-624 Die C) | | | |
| 7 day Modulus at 100% (MPa) | 1.04 | 158 | 179 |
| (ASTM D2370) | | | |
| 7 day wet peel adhesion to SPF (1), | 0 | 3.4 | 5.8 |
| peel force (N/m) | | | |
| 7 day wet peel adhesion to unprimed | 140 | 3.9 | 5.5 |
| APP Cap, peel force (N/m) | | | |
| 7 day wet peel adhesion to primed | 140 | 4.1 | 5.1 |
| APP Cap, peel force (N/m) | | | |

It will be seen that there is a significant improvement in physical properties compared to the Ref. 1. The addition of resin (iii) in example 1 provided reinforcement to the resulting coating film produced while minimizing impact on viscosity. Any inorganic reinforcement e.g. by the introduction of inorganic reinforcement such as precipitated calcium carbonate would have caused a large increase in viscosity.

Table 2a provides details of the formulations of coatings Examples 4 to 6 which each contain Resin 1 reactive resin as a reinforcing agent and Polymer 1 both having been identified above.

TABLE 2a

| | Ex. 4B | Ex. 5C | Ex. 6D |
|---|---|---|---|
| | (% wt.) | (% wt.) | (% wt.) |
| Polymer 1 | 39.00 | 32.00 | 34.00 |
| Resin 1 | 1.00 | 8.00 | 16.00 |
| Trimethyl terminated polydimethylsiloxane | 10.00 | 10.00 | |
| viscosity 2000 mPa · s | | | |
| Methyltrimethoxysilane | 3.00 | 3.00 | 3.00 |
| Titanium diisopropyldiethylacetoacetate | 0.75 | 0.75 | 0.75 |
| aminoethylaminopropyltrimethoxysilane | 0.04 | 0.04 | 0.04 |
| Titanium dioxide: pigment | 5.00 | 5.00 | 5.00 |
| Treated ground CaCO₃ | 41.21 | 41.21 | 41.21 |

Table 2b provides the physical property results of the compositions depicted in Table 2a

TABLE 2b

| | Ex. 4 | Ex. 5 | Ex. 6 |
|---|---|---|---|
| Viscosity (mPa · s at 25° C.) | 19000 | 25400 | 24800 |
| (ASTM D6694—15) | | | |
| 7 day Tensile strength (MPa) | 1.21 | 1.74 | 1.64 |
| (ASTM D2370) | | | |
| 7 day Elongation, % (ASTM D2370) | 198.3 | 260.5 | 231.1 |
| 7 day Tear Resistance (N/mm) | — | — | 9.61 |
| (ASTM D-624 Die C) | | | |
| 7 day Modulus at 100% (MPa) | 0.97 | 1.02 | — |
| (ASTM D2370) | | | |
| 7 day wet peel adhesion to SPF (1), | — | — | 1015.8 |
| peel force (N/m) | | | |
| 7 day wet peel adhesion to unprimed | — | — | 963.2 |
| APP Cap, peel force (N/m) | | | |
| 7 day wet peel adhesion to primed | — | — | 893.2 |
| APP Cap, peel force (N/m) | | | |

Again significant improvements can be seen in the physical property results. It may be appreciated that the use of reactive resin in the preferred range of from 10-25% by weight of the composition demonstrates improved tear resistance along with excellent mechanical properties without affecting the overall viscosity of the formulation. Without being bound to current theories, it is believed that the ability of the resin to form a continuous network dissipating the tear energy among the film is the mechanism by which the enhanced performance is achieved. It is believed that because the reactive resin participates in the crosslinking network formation, improved tensile and modulus properties are observed.

Furthermore, the results in Tables 1b and 2b show that use of reactive resins as hereinbefore described enhance adhesion to roofing substrates. Not least because of the enhanced wetting ability of the compositions comprising the resins.

Table 3 shows the comparative physical properties using identical test methods and equipment as above with respect to a commercial roof coating material GE® Enduris® 3502 High Solids Silicone Roof Coating from Momentive Performance Materials Inc as Comparative 1 (Comp. 1).

TABLE 3
Physical Properties of Comp. 1

| | Comp. 1 |
|---|---|
| Viscosity (mPa · s at 25° C.) (ASTM D6694—15) | 29000 |
| 7 day Tensile strength (MPa) (ASTM D2370) | 1.34 |
| 7 day Elongation, % (ASTM D2370) | 346 |
| 7 day Tear Resistance (N/mm) (ASTM D-624 Die C) | 6.79 |
| 7 day Modulus at 100% (MPa) (ASTM D2370) | 0.48 |
| 7 day wet peel adhesion to SPF (1), peel force (N/m) | 438 |
| 7 day wet peel adhesion to unprimed APP Cap, | 210 |
| peel force (N/m) | |
| 7 day wet peel adhesion to primed APP Cap, | 333 |
| peel force (N/m) | |

The examples herein show much higher, tensile strength, elongation and tear resistance performance than comp. 1 a commercial product in the roof coating market. It is believed without being bound to current theory that the mechanism by which our examples show differentiated performance is due to the organosilicate resins (iii) used form a continuous (and crosslinked) network that when exposed to a tear, readily dissipates energy evenly through the coating resisting the propagation of the tear. This differentiated performance is not readily achieved with conventional methods of reinforcing silicone polymers. These examples show that elastomeric coatings made from coating compositions as hereinbefore described outperform a current commercial silicone elastomeric coating in tensile and tear strength and elongation while maintaining the low application viscosity desired in the field. These performance properties demonstrate that compositions as described herein are tougher than a current market offering which is desirable for the application whilst avoiding unwanted increases in viscosity caused by reinforcing the composition with (additional) reinforcing filler.

Advantages of the compositions herein include high solids contents high tensile strength, elongation, and tear resistance, while also improving adhesion, and dirt pick-up due to prevention of polydimethylsiloxanes bleed out known in the art. Hence the enclosed compositions, once cured enables us to maximize tear resistance and overall mechanical properties while improving adhesion to roofing substrates without compromising viscosity.

In Table 4a self-levelling sealant composition is provided with Treated precipitated CaCO₃ (1) is a nano sized surface treated precipitated calcium carbonate having an average particle size of 0.07 μm and a surface area of 19 m²/g.

TABLE 4a

| | Ref. A | Ex. 3 |
|---|---|---|
| | (% wt.) | (coating G) |
| Polymer 2 | 50.0 | 30.0 |
| Resin 1 | | 20.0 |
| Methyltrimethoxysilane | 3.0 | 4.5 |
| Titanium diisopropyldiethylacetoacetate | 0.75 | 0.6 |
| Aminoethylaminopropyltrimethoxysilane | 0.04 | 0.6 |
| TiO₂ Pigment | 5.0 | 5.0 |
| Treated precipitated CaCO₃ (1) | | 15.0 |
| Treated ground CaCO₃ | 41.21 | 24.84 |

TABLE 4b

| | Ref. | Ex. 3 |
|---|---|---|
| Viscosity (mPa · s at 25° C.) (ASTM D6694—15) | 14000 | 70500 |
| 7 day Tensile strength (MPa) (ASTM D2370) | 1.19 | 1.49 |
| 7 day Elongation, % (ASTM D2370) | 142.2 | 464.3 |
| 7 day Tear Resistance (N/mm) (ASTM D-624 Die C) | 4.41 | 7.63 |
| 7 day Modulus at 100% (MPa) (ASTM D2370) | 1.04 | 0.36 |

The results with the above provide Strong tensile, elongation, and tear strength results relying on the resin only for reinforcement.

1. A moisture curable composition capable of cure to an elastomeric body, the composition comprising:
(i) an organopolysiloxane polymer having at least two silicon-bonded hydroxyl or hydrolysable groups per molecule and a viscosity of from 1,000 to 75,000 maPa·s at 25° C.;
(ii) a siloxane and/or silane cross-linker having at least two groups per molecule which are reactable with the hydroxyl or hydrolysable groups in the organopolysiloxane polymer (i);
(iii) an organosilicate resin comprising SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) and having a weight average molecular weight of from 3,000 to 30,000 g/mol, and a molar ratio of M groups:Q groups of from 0.50:1 to 1.20:1; and
(iv) a condensation cure catalyst.

2. The moisture curable composition in accordance with claim 1, wherein the organopolysiloxane polymer (i) is of the general formula
X₃₋ₙRₙSi—(Z)_{d}—(O)_{q}—(R¹_{y}SiO_{(4-y/2)z}—(SiR¹₂—Z)_{d}—Si—RₙX₃₋ₙ (1)
in which each X is independently a hydroxyl group or a hydrolysable group, each R is an alkyl, alkenyl or aryl group, each R¹ is an X group, alkyl group, alkenyl group or aryl group and Z is a divalent organic group; d is 0 or 1, q is 0 or 1 and (d+q)=1; and n is 0, 1, 2 or 3, y is 0, 1 or 2, and z is an integer.

3. The moisture curable composition in accordance with claim 2, wherein the organopolysiloxane polymer (i) is of the general formula
X₃₋ₙRₙSi—(Z)—(R¹_{y}SiO_{(4-y)/2)z}—(SiR¹₂—Z)—Si—RₙX₃₋ₙ
in which n is 0 or 1, and each X is an alkoxy group.

4. The moisture curable composition in accordance with claim 1, wherein the molar ratio of the total M siloxane units to total Q siloxane units of the organosilicate resin (iii) is from 0.6:1 to 0.8:1.4.

5. The moisture curable composition in accordance with claim 1, wherein the composition further comprises one or more reinforcing fillers and/or non-reinforcing fillers.

6. The moisture curable composition in accordance with claim 1, which composition, when mixed has a viscosity of 30,000 maPa·s or less at 25° C. and a solids content of at least 90%.

7. The moisture curable composition in accordance with claim 1, wherein the composition is further defined as a sealant composition, an elastomeric coating composition, or an adhesive composition.

8. The moisture curable composition in accordance with claim 7, being the sealant composition and which is capable of being applied as a paste to a joint between two adjacent substrate surfaces where it can be worked, prior to curing, to provide a smooth surfaced mass which will remain in its allotted position until it has cured into an elastomeric body adherent to the adjacent substrate surfaces.

9. The moisture curable composition in accordance with claim 7, which is self-levelling.

10. An elastomeric coating obtained by curing the moisture curable composition in accordance with claim 7 on a substrate,
(i) as a weatherproof coating for concrete and/or construction substrate surfaces;
(ii) as or in a flashing agent;
(iii) as or in a roof seal; and/or
(iv) in an intumescent coating.

11. A method of applying the moisture curable composition in accordance with claim 1 over a roofing surface or substrate by applying the moisture curable composition in the form of a moisture curable elastomeric coating composition with an applicator and allowing the composition to cure.

12. The method of applying a in accordance with claim 11, wherein the applicator is a sprayer, a brush, a roller, or a squeegee.

13. The method of applying in accordance with claim 11, wherein the composition at least partially penetrates into a roofing fabric prior to cure and as such the resulting elastomeric coating is in and/or on the roofing fabric once cured.

14. The method of applying in accordance with claim 11, onto a pre-prepared weatherproof roofing membrane by coating the membrane with at least one coat of the moisture curable elastomeric coating composition and allowing the coating to cure.

15. The method of applying in accordance with claim 14, as a remedial renovating process for weatherproofing a leaking roof and/or leaking roofing membrane.

16. (canceled)

17. A method of improving tensile strength, modulus, tear resistance and/or adhesion of an elastomeric body obtained or obtainable by curing a moisture curable composition capable of cure to an elastomeric body, the composition comprising:
(i) an organopolysiloxane polymer having at least two silicon-bonded hydroxyl or hydrolysable groups per molecule and a viscosity of from 1,000 to 75,000 maPa·s at 25° C.;
(ii) a siloxane and/or silane cross-linker having at least two groups per molecule which are reactable with the hydroxyl or hydrolysable groups in the organopolysiloxane polymer (i); and
(iv) a condensation cure catalyst;
the method comprising introducing (iii) an organosilicate resin into the composition prior to cure, and subsequently curing the composition;
wherein the organosilicate resin (iii) comprises SiO_{4/2} (Q) siloxane units and R²₃SiO_{1/2} (M) siloxane units wherein each R² is selected from hydrocarbon groups, —OH and/or alkoxy containing groups and which M groups are reactive with components (i) and/or (ii) and having a weight average molecular weight of from 3,000 to 30,000 g/mol, and a molar ratio of M groups:Q groups of from 0.50:1 to 1.20:1.

18. A silicone-based elastomer obtainable or obtained by curing the moisture curable composition in accordance with claim 1.
